(19) United States
(12) Patent Application Publication
(10) Pub. No.: US 2013/0300223 A1
(43) Pub. Date: Nov. 14, 2013

(54) MOLDED STRUCTURE AND MOTOR

(71) Applicants: Kenji Kondo, Nara (JP); Masanori Morita, Osaka (JP); Seiji Kurozumi, Osaka (JP)

(72) Inventors: Kenji Kondo, Nara (JP); Masanori Morita, Osaka (JP); Seiji Kurozumi, Osaka (JP)

(73) Assignee: PANASONIC CORPORATION, Kadoma-shi, Osaka (JP)

(21) Appl. No.: 13/981,280

(22) PCT Filed: Jan. 17, 2012
(86) PCT No.: PCT/JP2012/000225

§ 371 Date: Jul. 23, 2013

(30) Foreign Application Priority Data
Jan. 25, 2011 (JP) 2011-012601

(51) Int. Cl. H02K 1/12; B32B 7/12

(52) U.S. Cl. CPC H02K 1/12; B32B 7/12
USPC 310/43; 428/354

(57) ABSTRACT

A molded structure according to the present invention is formed from a molding resin which includes at least a thermosetting resin, a thermoplastic resin, and an electrically insulating inorganic filler subjected to a surface treatment with a coupling agent, and which contains the coupling agent in an amount 0.5 times to 2 times the amount of the coupling agent necessary to cover the total surface area of the inorganic filler. Thus, the adhesion is improved between the resin and the inorganic filler in the molding resin, and a molded structure can be achieved which has a high thermal conductivity and high dimensional stability.

### TECHNICAL FIELD

The present invention relates to a molded structure obtained by mold forming of a magnet coil wound on an iron core, and a motor.

### BACKGROUND ART

Conventionally, a reduction in size, a reduction in thickness, and an increase in output power have been strongly desired for appliances such as motors for household electrical appliances and transformers. In addition, appliances have been required to be low-noise and low-vibration appliances, in consideration of the environment for the usage of the appliances.

In order to meet the requirement, a low-noise and low-vibration motor has been proposed which is obtained by mold forming of a magnet coil wound on an iron core with the use of a molding resin. It is to be noted that the configuration of the motor will be described in detail in a subsequent exemplary embodiment.

In recent years, due to rising of environmental awareness in the market, there have been increasing demands for not only low environmental burdens, but also resources saving and energy saving such as reductions in size and thickness and an increase in output power density.

However, with the reductions in size and thickness and the increase in output power density for products, heat generated by magnet coils is increased, and problems are thus caused, such as product safety deterioration and thermally deteriorated peripheral components.

Therefore, in response to the higher function requirements including more heat release for molding resins constituting a stator of motor, and the like, for example, the following studies described in Patent Literature 1 to Patent Literature 5 have been carried out.

The invention disclosed in Patent Literature 1 achieves higher thermal conductivity and higher strength of a molding resin by an epoxy resin containing therein at least either a silica filler subjected to a coupling treatment or an alumina filler. However, because of the high viscosity of the epoxy resin itself, the filler is not able to be dispersed uniformly. Thus, the filler is dispersed uniformly by restricting the molecular weight of the epoxy resin or putting a limit on the kneading method. Therefore, there are problems such as longer production tact time (cycle time). In addition, the molding resin has difficulty with ensuring the flame retardancy required for motors, transformers, and the like for household electrical appliances, and can achieve only a thermal conductivity of 1.0 W/m·K or less. Therefore, there has been a problem that it is not possible to release and thereby reduce heat generated by magnet coils with the reduction in size, the reduction in thickness, and the increase in output power for molded structures.

In addition, the invention disclosed in Patent Literature 2 achieves highly increased thermal conductivity and dimensional stability of a molding resin by containing an unsaturated polyester resin as a thermosetting resin, a low shrinkage agent as a thermoplastic resin, and a filler that has a high thermal conductivity. However, while the thermoplastic resin can achieve high dimensional stability, the thermal conductivity is achieved only on the order of 1.2 W/m·K. Therefore, there has been a problem that it is not possible to release and thereby reduce heat generated by magnet coils with the reduction in size, the reduction in thickness, and the increase in output power for molded structures.

Furthermore, the invention disclosed in Patent Literature 3 achieves high thermal conductivity of a molding resin by an unsaturated polyester resin containing therein 65% to 80% of hard-burned magnesia. However, the molding resin has difficulty in ensuring the flame retardancy required for molding resins of motors, transformers, and the like for household electrical appliances.

Furthermore, the invention disclosed in Patent Literature 4 achieves highly increased thermal conductivity and improved flame retardancy of a molding resin by an unsaturated polyester resin containing therein alumina that has a high thermal conductivity and red phosphorus that provides flame retardancy. However, mold corrosion is caused by gas generated due to red phosphorus when the molding resin is molded, and the phosphorus contained in the molding resin has the possibility of failing to be admitted for use in environment-conscious products.

Furthermore, the invention disclosed in Patent Literature 5 achieves highly increased thermal conductivity of a molding resin by the molding resin containing a metal powder in an epoxy resin and a filler. However, because of the high viscosity of the epoxy resin itself, the filler is not able to be dispersed uniformly. Thus, the filler is dispersed uniformly by restricting the molecular weight of the epoxy resin or putting a limit on the kneading method. Therefore, there are problems such as longer production tact time (cycle time). In addition, the conductive metal powder may be incorporated between the winding wires in the mold forming of the magnet coil wound on the iron core in some cases. If there are any pinholes in the film of the winding wire near the metal powder, the withstand voltage of the molded structure will be decreased. Furthermore, because the molding resin is filled with the metal powder, there is a problem that the metal mold is damaged by the metal powder in a short period of time in the mold forming.

PTL 1: Japanese Patent No. 3501905

PTL 2: Unexamined Japanese Patent Publication No. 2001-226573

PTL 3: Japanese Patent No. 3622724

PTL 4: Japanese Patent No. 4186930

PTL 5: Unexamined Japanese Patent Publication No. 2004-143368

### SUMMARY OF THE INVENTION

A molded structure according to the present invention is formed from a molding resin which includes at least a thermosetting resin, a thermoplastic resin, and an electrically insulating inorganic filler subjected to a surface treatment with a coupling agent, and which contains the coupling agent in an amount 0.5 times to 2 times the amount of the coupling agent necessary to cover the total surface area of the inorganic filler.

Thus, the adhesion is improved between the resin and the inorganic filler in the molding resin, and a molded structure can be achieved which has a high thermal conductivity and high dimensional stability.

Furthermore, a motor according to the present invention is configured by mold forming with the molding resin. Thus, a motor can be achieved which is highly safe so as to be unlikely to burn out, and reduced in size and thickness, and has high output power.

### BRIEF DESCRIPTION OF THE DRAWINGS

FIG. 1 is a cross-sectional view illustrating the configuration of a motor according to a first exemplary embodiment of the present invention.

FIG. 2 is a diagram showing the relationship between the winding wire temperature and the thermal conductivity of a molding resin in the motor according to the exemplary embodiment.

### DETAILED DESCRIPTION OF THE PREFERRED EMBODIMENTS

A molded structure and a motor using the molded structure according to an exemplary embodiment of the present invention will be described below with reference to the drawings. It is to be noted that the present invention is not limited by the exemplary embodiment.

### Exemplary Embodiment

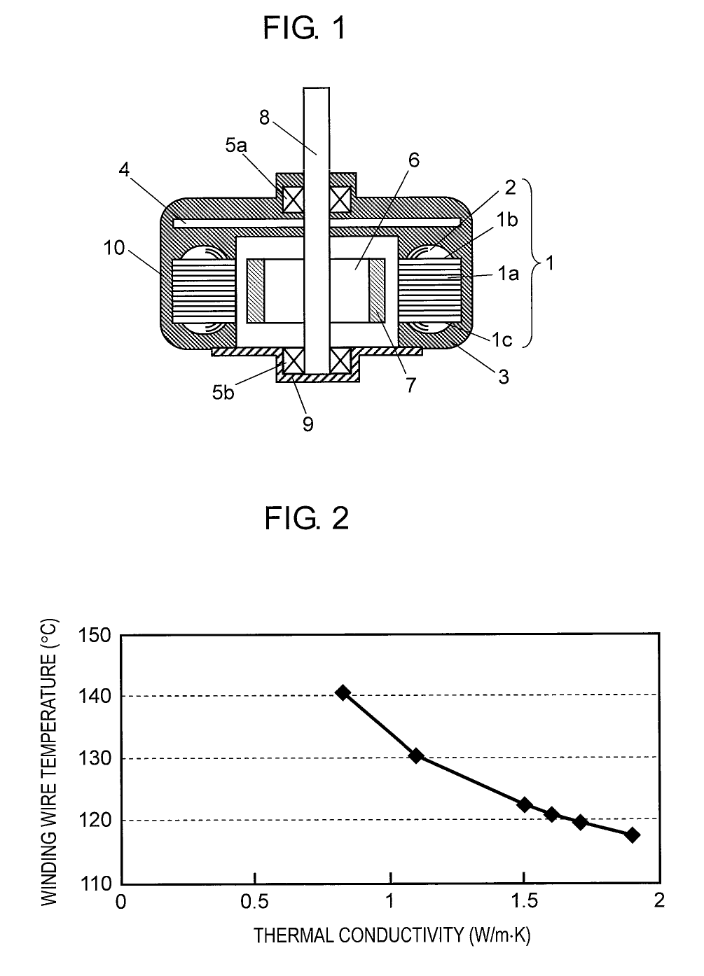

The molded structure according to the exemplary embodiment of the present invention will be described below with reference to FIG. 1. It is to be noted that a motor (small-size air-conditioning fan motor) for household electrical appliances, formed from a molded structure obtained by mold forming of a magnet coil wound on an iron core with a molding resin, will be described as an example with reference to FIG. 1.

FIG. 1 is a cross-sectional view illustrating the configuration of the motor according to the exemplary embodiment of the present invention.

As shown in FIG. 1, the motor is composed of stator 1, driving circuit 4, and rotor 6 that has an outer periphery provided with permanent magnet 7. Stator 1 of the motor is composed of winding wire 2 wound on iron core 1a with a winding frame interposed therebetween, and integrally formed so as to be surrounded by molded structure 3 of a molding resin, excluding the inner periphery of iron core 1a. In this case, on one end surface 1b of stator 1, a bearing housing for housing bearing 5a for supporting rotor 6 is integrally formed with molded structure 3 of the molding resin, and other end surface 1c of the stator is provided with an opening. Driving circuit 4 is placed between winding wire 2 and bearing 5a, and integrally formed along with stator 1 so as to be surrounded by molded structure 3.

In addition, rotor 6 has shaft 8 with one end inserted from the opening of stator 1 into bearing 5a, then the other end inserted into bearing 5b housed in a bearing housing section formed for bracket 9. Further, other end surface 1c of stator 1 is covered by bracket 9, so that shaft 8 of rotor 6 is rotatably supported in stator 1 via bearings 5a and 5b.

With the configuration described above, the vibration generated by iron core 1a and winding wire 2 with rotation of rotor 6 is suppressed by molded structure 3 constituting stator 1 to achieve a motor which is less likely to vibrate and highly silent.

Furthermore, the molding resin constituting molded structure 3 according to the present exemplary embodiment is composed of a thermosetting resin of, for example, an unsaturated polyester resin, a thermoplastic resin of, for example, a polystyrene resin, and an insulating inorganic filler subjected to a surface treatment with a coupling agent, and the molding resin contains the coupling agent in an amount 0.5 times to 2 times the amount of the coupling agent for covering the total surface area of the inorganic filler. Furthermore, the polystyrene resin as a thermoplastic resin is incompatible with the unsaturated polyester resin as a thermosetting resin.

In this case, as described in detail below, the content of the inorganic filler is preferably twice or more than the amount of resin in the molded resin. In addition, the content of the thermosetting resin and thermoplastic resin preferably ranges from 16% to 25% of the molding resin, and the mixture ratio of the thermoplastic resin to the total content of the thermosetting resin and thermoplastic resin preferably ranges from 11% to 67%.

In addition, the unsaturated polyester resin as a thermosetting resin preferably has a viscosity on the order of 300 mPa·s. Thus, the inorganic filler, a glass fiber and the like can be easily dispersed uniformly by a common kneading machine (the blade shape is, for example, dual-armed, sigma-form, z-form, or the like).

It is to be noted that when an epoxy resin with a viscosity of 3000 mPa·s is used as the thermosetting resin, it is difficult to uniformly disperse and knead the inorganic filler and a glass fiber. If the molding resin such as the epoxy resin is kneaded for a longer period of time, the molding resin will start curing by friction heat, thus making the molding resin unlikely to be incorporated between the winding wires during the mold forming. Therefore, even in the case of using a molding resin composed of an epoxy resin with a high thermal conductivity or the like, the suppression of an increase in magnet coil temperature or the vibration-proofing property will be decreased as a molded structure.

Thus, a molded structure can be achieved which has a thermal conductivity of 1.5 W/m·K or more and flame retardancy of UL standard 94V-0 ( 1/16 inch thick) (hereinafter, referred to as flame retardancy V-0). More specifically, the use of the molding resin can reduce thinnest section 10 of the molded structure in the motor shown in FIG. 1 in thickness, for example, to 1.6 mm, by on the order of 20% as compared with conventional resins. As a result, a reduction in motor size and the flame retardancy V-0 can be both achieved.

In addition, the molding resin is composed of only the resin of the thermosetting resin and thermoplastic resin, and the insulating inorganic filler. Therefore, even when winding wire 2 has film defects (initial pinholes, winding scratch, or the like.), the withstand voltage between winding wires 2 can be prevented from being decreased in the mold forming. As a result, the withstand voltage can be prevented from being decreased over the entire molded structure constituting the motor.

Properties of the molding resin constituting the molded structure according to the present exemplary embodiment will be described in detail below.

First, (Table 1) below shows the thermal conductivity obtained from molding resins formed by kneading differently compatible thermoplastic resins with the unsaturated polyester resin as the thermosetting resin.

TABLE 1

| Type of | Presence or | Thermal |
|---|---|---|
| Thermoplastic | Absence of | Conductivity |
| Resin | Compatibility | (W/m · K) |
| Polyester | Presence | 1.1 |
| Polystyrene | Absence | 1.5 |
| Polystyrene | Presence | 1.2 |
| Acrylic | Absence | 1.1 |
| Acrylic | Semi- | 0.9 |
| | compatible | |

As shown in (Table 1), it is found that the molding resin obtained by kneading the thermoplastic resin incompatible with the unsaturated polyester resin has a thermal conductivity improved as compared with the molding resin obtained by kneading the compatible thermoplastic resin. In particular, when the incompatible polystyrene resin is used, a highest thermal conductivity of 1.5 W/m·K is achieved. Therefore, the molding resin with a high thermal conductivity can be obtained by kneading the incompatible polystyrene resin as the thermoplastic resin with the unsaturated polyester resin as the thermosetting resin.

Next, (Table 2) below shows results of the dimensional stability and thermal conductivity of the molding resin, depending on whether or not the inorganic filler is subjected to a surface treatment with a coupling agent, for sample A to sample J which have varying mixture ratios of the polystyrene resin to the total content of the unsaturated polyester resin and polystyrene resin. It is to be noted that the unsaturated polyester resin and the polystyrene resin are collectively expressed as the “resin” hereinafter. In addition, the dimensional stability Δ, ◯, or ⊙ is determined based on the dimensional accuracy required in the case of forming a molded structure of a small-size motor.

TABLE 2

| | Sample A | Sample B | Sample C | Sample D | Sample E | Sample F | Sample G | Sample H | Sample I | Sample J |
|---|---|---|---|---|---|---|---|---|---|---|
| Mixture | 11% | | 25% | | 33% | | 67% | | 80% | |
| Ratio of | | | | | | | | | | |
| Polyester | | | | | | | | | | |
| Resin to | | | | | | | | | | |
| Resin | | | | | | | | | | |
| Coupling | Yes | No | Yes | No | Yes | No | Yes | No | Yes | No |
| Treatment of | | | | | | | | | | |
| Inorganic | | | | | | | | | | |
| Filler | | | | | | | | | | |
| Dimensional | ◯ | Δ | ◯ | ◯ | ◯ | ◯ | ◯ | ◯ | ⊙ | ◯ |
| Stability | | | | | | | | | | |
| Thermal | 1.9 | 1.8 | 1.7 | 1.6 | 1.6 | 1.6 | 1.6 | 1.5 | 1.2 | 1.2 |
| Conductivity | | | | | | | | | | |
| (W/m · K) | | | | | | | | | | |

First, as shown by sample C to sample H in (Table 2), in the case of the mixture ratio of the polystyrene resin to the resin ranging from 25% to 67%, molding resins which have a high thermal conductivity ranging from 1.5 W/m·K to 1.7 W/m·K and excellent dimensional stability are achieved with or without the surface treatment of the inorganic filler with the coupling agent.

However, as shown by sample I and sample J, in the case of the mixture ratio of the polystyrene resin to the resin ranging from more than 67% to 80%, it is found that greater dimensional stability is achieved with or without the surface treatment of the inorganic filler with the coupling agent, while the thermal conductivity is decreased to 1.2 W/m·K. This is considered to be due to the decreased adhesion between the resin and the inorganic filler in the molding resin, because the increased amount of the polystyrene resin reduces shrinkage after resin molding.

In addition, as shown by sample A and sample B in (Table 2), in the case of the mixture ratio of the polystyrene resin to the resin being 11%, it is found that a high thermal conductivity ranging from 1.8 W/m·K to 1.9 W/m·K is achieved, while the dimensional stability is decreased in sample B without the surface treatment of the inorganic filler with the coupling agent.

More specifically, the mixture ratio of the polystyrene resin to the resin ranging from 11% to 67% and the inorganic filler subjected to the surface treatment with the coupling agent achieve molding resins that have a high thermal conductivity ranging from 1.5 W/m·K to 1.9 W/m·K and excellent dimensional stability. This is considered to be due to the fact that the surface treatment of the inorganic filler with the coupling agent improves the adhesion between the resin and the inorganic filler in the molding resin to reduce the shrinkage factor.

Therefore, in the present embodiment, the inorganic filler subjected to the surface treatment with the coupling agent is used to prepare a molded structure from the molding resin in which the mixture ratio of the polystyrene resin to the resin ranges from 11% to 67%. Thus, the molded structure which has excellent dimensional stability and high radiation performance can be used to achieve motors which have a reduction in size, a reduction in thickness, and an increase in output power, and excellent reliability such as heat resistance.

Next, (Table 3) below shows results for the storage stability of the molding resin depending on whether the surface treatment with the coupling agent is applied or not, in the case of sample E with the inorganic filler subjected to the surface treatment with the coupling agent and sample F without the surface treatment, as shown in (Table. 2). It is to be noted that a silane coupling agent is used as the coupling agent for evaluations in subsequent (Table 3) through (Table 6). In addition, the storage stability is evaluated, in the case of storing the molding resin, as a period of time for which a state can be maintained where the molding resin can be practically formed into molded structures.

TABLE 3

| | Sample E | Sample F |
|---|---|---|
| Unsaturated Polyester Resin and | 21% | 21% |
| Polystyrene Resin | | |
| Inorganic Filler | 76.8% | 77% |
| Silane Coupling Agent | 0.2% | 0% |
| Others | 2% | 2% |
| (Curing Agent, Lubricant, and | | |
| the like) | | |
| Storage Stability (25° C.) | >2 weeks | 1 week |

As shown by sample E in (Table 3), it is found that the surface treatment of the inorganic filler with the coupling agent improves the storage stability twice or more as much as compared with sample F without the surface treatment. This is considered to be due to the fact the polystyrene resin incompatible with the unsaturated polyester resin is prevented from being easily separated after kneading, because the coupling agent improves the adhesion between the inorganic filler and the unsaturated polyester resin and between the inorganic filler and the polystyrene resin.

Next, (Table 4) below shows the relationship between flame retardancy and the ratio between the total content (resin amount) of the unsaturated polyester resin and polystyrene resin and the content of metal hydrate as the inorganic filler in the molding resin.

In (Table 4), flame retardancy is evaluated based on UL94V-0, V-1, and V-2 standards in an UL burn test method, with the use of sample K, sample L, and sample M of 1.6 mm thick ( 1/16 inch) that are different in the ratio between the resin amount of the unsaturated polyester resin and polystyrene resin and the metal hydrate in the molding resin. It is to be noted that while aluminum hydroxide as an example is described as the metal hydrate for providing flame retardancy with reference to (Table 4), the metal hydrate is not limited to this aluminum hydroxide. Further, while calcium carbonate as an example is described as the inorganic filler other than the metal hydrate with reference to (Table 3), the inorganic filler is not limited to this calcium carbonate.

TABLE 4

| | Sample K | Sample L | Sample M |
|---|---|---|---|
| Unsaturated Polyester Resin | 21% | 21% | 21% |
| and Polystyrene Resin | | | |
| Metal Hydrate | 35% | 42% | 69.8% |
| (Aluminum Hydroxide) | | | |
| Calcium Carbonate | 34.8% | 27.8% | 0% |
| Silane Coupling Agent | 0.2% | 0.2% | 0.2% |
| Others | 9% | 9% | 9% |
| (Curing Agent, Lubricant, and | | | |
| the like) | | | |
| Flame Retardancy (UL94 | V-2 | V-0 | V-0 |
| 1/16 inch) | | | |

As shown in (Table 4), flame retardancy of V-2 is indicated in the case of sample K in which the ratio of the metal hydrate is less than twice the resin amount of the unsaturated polyester resin and polystyrene resin. On the other hand, it is found that high flame retardancy of V-0 is achieved in the case of sample L in which the ratio of the metal hydrate is twice the resin amount and sample M in which the ratio is more than twice the resin amount.

Accordingly, molding resins and molded structures with flame retardancy of V-0 can be achieved by the molding resin containing therein the metal hydrate at the ratio of twice or more than the total content (resin amount) of the unsaturated polyester resin and polystyrene resin. Therefore, there is no need to use any flame retardant containing halogen, phosphorus, and the like, which are limited on the use thereof from the standpoint of environmental burden. Furthermore, the use of the molded structure can achieve a motor with excellent flame retardancy of V-0, which is easily reduced in size.

It is to be noted that magnesium hydroxide may be used besides aluminum hydroxide, for example, as a metal hydrate that exhibits flame retardancy at 400° C. or lower.

Next, (Table 5) below shows results for the thermal conductivity and strength of the molding resin in sample N to sample R that have the coupling agent compounded in varying proportions with respect to the amount of the coupling agent regarded as 1 for coating the total surface area of the inorganic filler contained in the molding resin. It is to be noted that an example will be described below in which aluminum hydroxide with a specific surface area of 0.9 m² per unit weight is used as the inorganic filler, whereas a silane coupling agent that covers a surface of 300 m² per unit weight is used as the coupling agent.

TABLE 5

| | Sample N | Sample O | Sample P | Sample Q | Sample R |
|---|---|---|---|---|---|
| Unsaturated Polyester Resin | 21% | 21% | 21% | 21% | 21% |
| and Polystyrene Resin | | | | | |
| Aluminum Hydroxide | 77.0% | 76.9% | 76.8% | 76.6% | 76.4% |
| (Specific Surface Area: 0.9 m2/g) | | | | | |
| Silane Coupling Agent | 0% | 0.1% | 0.2% | 0.4% | 0.6% |
| (Surface Coating: 300 m2/g) | | | | | |
| Others | 2.0% | 2.0% | 2.0% | 2.0% | 2.0% |
| (Curing Agent, Lubricant, and | | | | | |
| the like) | | | | | |
| Specific Surface Area Ratio | 0 | 0.5 | 1 | 2 | 3 |
| (Silane Coupling | | | | | |
| Agent/Aluminum Hydroxide) | | | | | |
| Thermal Conductivity | 1.5 | 1.6 | 1.6 | 1.6 | 1.6 |
| (W/m · K) | | | | | |
| Strength (MPa) | 54 | 55 | 58 | 50 | 36 |

First, as shown by sample O to sample R in (Table 5), when the ratio (specific surface area ratio (silane coupling agent/inorganic filler)) of the amount of the silane coupling agent for covering the total surface area of the inorganic filler ranges from 0.5 to 2, molding resins are achieved which have a high thermal conductivity of 1.6 W/m·K and a mechanical strength of 50 MPa or higher.

More specifically, the silane coupling agent compounded in a ratio ranging from 0.5 to 2 can improve the thermal conductivity by 0.1 W/m·K while the mechanical strength is comparable, as compared with sample N without using the silane coupling agent. As a result, high-power and highly reliable motors can be achieved by further suppressing an increase in winding wire temperature while maintaining the mechanical strength of the motor.

However, as shown by sample R, when the amount of the silane coupling agent is excessively large with the ratio of 3, the molding resin undergoes a decrease in mechanical strength, and the molded structure or motor thus undergoes a decrease in reliability.

Accordingly, as the content of the coupling agent, the silane coupling agent is preferably compounded in a ratio ranging from 0.5 to 2 with respect to the amount of the silane coupling agent for coating the total surface area of the inorganic filler.

Next, (Table 6) below shows the relationship with the kneadability of the molding resin, in sample S to sample W that are different in the compounding ratio of the total content (resin amount) of the unsaturated polyester resin and polystyrene resin to the molding resin.

TABLE 6

| | Sample S | Sample T | Sample U | Sample V | Sample W |
|---|---|---|---|---|---|
| Unsaturated | 14% | 16% | 21% | 25% | 28% |
| Polyester | | | | | |
| Resin and | | | | | |
| Polystyrene | | | | | |
| Resin | | | | | |
| Inorganic | 83.8% | 81.8% | 76.8% | 74.8% | 77.8% |
| Filler | | | | | |
| Silane | 0.2% | 0.2% | 0.2% | 0.2% | 0.2% |
| Coupling | | | | | |
| Agent | | | | | |
| Others | 2% | 2% | 2% | 2% | 2% |
| Kneadability | X | ◯ | ◯ | ◯ | X |

As shown by sample T to sample V in (Table 6), it is found that the kneadability with the inorganic filler is favorable when the compounding ratio of the unsaturated polyester resin and polystyrene resin to the molding resin ranges from 16% to 25%. Thus, the molding resin or molded structure with excellent moldability can be used to achieve a motor with a high degree of dimensional accuracy and with excellent reliability.

However, as shown by sample S in (Table 6), when the compounding ratio of the unsaturated polyester resin and polystyrene resin to the molding resin is 14% which is less than 16% in sample T, the inorganic filler and the resin are not coupled, and thus unable to be kneaded, due to lack of resin in the molding resin.

In addition, as shown by sample W in (Table 6), when the compounding ratio of the unsaturated polyester resin and polystyrene resin to the molding resin is 28% which is more than 25% in sample V, the fluidity of the molding resin is excessively increased. Therefore, the handling ability of the molding resin is decreased to make the mold forming impossible.

Accordingly, the compounding ratio of the unsaturated polyester resin and polystyrene resin to the molding resin preferably ranges from 16% to 25%.

The heat dissipation performance of the molding resin constituting the molded structure formed as described above will be described below with reference to FIG. 2. It is to be noted that a small-size air-conditioning motor formed with a molded structure composed of the molding resin described above will be described as an example with reference to FIG. 2.

FIG. 2 is a diagram showing the relationship between the winding wire temperature and the thermal conductivity of the molded structure in the motor according to the exemplary embodiment of the present invention.

As shown in FIG. 2, when the thermal conductivity of the molded structure is 1.9 W/m·K, an increase in winding wire temperature can be suppressed to on the order of 118° C. On the other hand, when the thermal conductivity of the molded structure is 0.75 W/m·K, the temperature of the winding wire is increased to 140° C. Therefore, the improved thermal conductivity can provide a margin of, for example, 20° C. for the increase in wiring wire temperature in the motor. Thus, it is possible to improve the reliability of the molded structure, and achieve a reduction in size and an increase in output power.

More specifically, it is found that heat generated by, for example, the winding wire of the motor can be more efficiently released to the outside by increasing the thermal conductivity of the molding resin constituting the molded structure, with the predetermined compounding ratio described with reference to (Table 1) to (Table 6).

According to the present exemplary embodiment, an increase in winding wire temperature and an increase in temperature in respective sections of the motor can be reduced by the molded structure with a high thermal conductivity. As a result, electronic components, and the like constituting driving circuit 4 can be improved in endurance to make improvements in reliability and safety for appliances such as motors.

It is to be noted that while the unsaturated polyester resin as an example has been described as the thermosetting resin in the present embodiment, the thermosetting resin is not limited to this unsaturated polyester resin. The thermosetting resin may be, for example, an unsaturated epoxy-modified polyester resin. This resin achieves a similar effect.

It is to be noted that while the polystyrene resin as an example has been described as the thermoplastic resin in the present exemplary embodiment, the thermosetting resin is not limited to this polystyrene resin. For example, the thermoplastic resin may be, for example, a styrene-butadiene resin incompatible with the thermosetting resin such as the unsaturated polyester resin. This resin achieves a similar effect.

Further, while the calcium carbonate as an example has been described as the inorganic filler other than the metal hydrate in the present exemplary embodiment, the inorganic filler is not limited to this calcium carbonate. The inorganic filler may be, for example, talc or zinc oxide. This inorganic filler achieves a similar effect.

Further, while the silane coupling agent as an example has been described as an agent for the surface treatment of the inorganic filler in the present exemplary embodiment, the agent is not limited to this silane coupling agent. The agent may be, for example, a titanium coupling agent. This agent achieves a similar effect.

The molded structure according to the present invention is formed from a molding resin which includes at least a thermosetting resin, a thermoplastic resin, and an electrically insulating inorganic filler subjected to a surface treatment with a coupling agent, and which contains the coupling agent in an amount 0.5 times to 2 times the amount of the coupling agent necessary to cover the total surface area of the inorganic filler. Thus, the adhesion is improved between the resin and the inorganic filler in the molding resin, and a molded structure can be achieved which has a high thermal conductivity and high dimensional stability.

Furthermore, in the molded structure according to the present invention, the thermosetting resin is an unsaturated polyester resin, and the thermoplastic resin is a polystyrene resin incompatible with the unsaturated polyester resin. Thus, the adhesion is improved between the resin and the inorganic filler in the molding resin, and a high thermal conductivity and high dimensional stability can be achieved.

Furthermore, in the molded structure according to the present invention, the inorganic filler contains a metal hydrate. Thus, the flame retardancy of the molding resin can be improved without containing any substances with high environmental burdens.

Furthermore, in the molded structure according to the present invention, the content of the metal hydrate is twice or more than the total content of the thermosetting resin and thermoplastic resin. Thus, the flame retardancy of the molding resin can be further improved.

Furthermore, in the molded structure according to the present invention, the total content of the thermosetting resin and thermoplastic resin in the molding resin ranges from 16% to 25% of the molding resin, and the mixture ratio of the thermoplastic resin to the total content ranges from 11% to 67%. Thus, the molding resin can achieve high moldability, high thermal conductivity, and high dimensional stability.

Furthermore, the motor according to the present invention is configured by mold forming with the molding resin. Thus, a motor can be achieved which is highly safe so as to be unlikely to burn out, and reduced in size and thickness, and has high output power

### INDUSTRIAL APPLICABILITY

The present invention is useful in the field of molded structures formed from a molding resin that requires high safety and reliability, and in technical fields such as, in particular, a motor that uses a molded structure and requires a reduction in size and an increase in output power.

### REFERENCE MARKS IN THE DRAWINGS

1 stator

1a iron core

1b, 1c end surface

2 winding wire

3 molded structure

4 driving circuit

5a, 5b bearing

6 rotor

7 permanent magnet

8 shaft

9 bracket

10 thinnest section

1. A molded structure formed from a molding resin,
the molding resin including:
at least a thermosetting resin;
a thermoplastic resin; and
an electrically insulating inorganic filler subjected to a surface treatment with a coupling agent, and
the molding resin containing the coupling agent in an amount 0.5 times to 2 times an amount of the coupling agent necessary to cover a total surface area of the inorganic filler.

2. The molded structure according to claim 1, wherein the thermosetting resin is an unsaturated polyester resin, and the thermoplastic resin is a polystyrene resin incompatible with the unsaturated polyester resin.

3. The molded structure according to claim 1, wherein the inorganic filler contains a metal hydrate.

4. The molded structure according to claim 3, wherein a content of the metal hydrate is twice or more than a total content of the thermosetting resin and the thermoplastic resin.

5. The molded structure according to claim 1, wherein a total content of the thermosetting resin and the thermoplastic resin in the molding resin ranges from 16% to 25% of the molding resin, and a mixture ratio of the thermoplastic resin to the total content ranges from 11% to 67%.

6. A motor comprising a molded structure obtained by mold forming of a magnet coil wound on at least an iron core with the molding resin according to claim 1.
